(19) United States
(12) Patent Application Publication
(10) Pub. No.: US 2004/0042455 A1
(43) Pub. Date: Mar. 4, 2004

(54) Relation-based fuzzy- and discrete-logic based multidimensional decision and dynamic tuning control

(76) Inventor: Eero Wallenius, Kangasala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/448,471

(22) Filed: May 30, 2003

Related U.S. Application Data
(60) Provisional application No. 60/384,891, filed on May 31, 2002.

(51) Int. Cl. H04L 12/28

(52) U.S. Cl. 370/392; 370/469

(57) ABSTRACT

An admission control unit for users in a wireless communication system. The unit being arranged to control the admission of calls arriving from users depending on a parameter which is representative of the load in the system. The load parameter is derived from a fuzzy logic composition of at least two indicators, each defining different performance characteristics of the load.

### FIELD OF INVENTION

The present invention relates to policy-based decision-making in communications network elements.

The invention has been developed primarily for use in Third Generation (3G) telecommunications networks, and more particularly for allowing admission control in an Internet Protocol (IP) Radio Access Network (RAN) element. However, it will be appreciated that the invention has application in other policy-based decision-making elements that use rule-based logic for configuration and dynamic tuning, including (but not limited to) network elements, Policy Decision Points (PDPs), and rule-based engines, whether acting alone or co-operating with other decision-making elements.

### BACKGROUND OF INVENTION

Proposed 3G networks have considerably higher capabilities than, say, GSM in terms of data rates and potential data quality. Whilst this opens up possibilities for improved services to users of mobile communications equipment, it also substantially complicates other issues, such as controlling user access. The matter is complicated by factors such as Guaranteed Bit-Rate (GBR) services based on Quality of Service (QoS) parameters, in which a user will (typically) pay a premium for access to a predetermined level of service.

Decisions about access to network resources are typically made in network elements, either at the cell level or at the subscription level in, for example, a Serving GPRS Support Node (SGSN). Admission control procedures must ensure adequate network resources for 3G QoS on IP (Internet Protocol) and UMTS (Universal Mobile Telecommunications System) layers by controlling the access of the network connections based on the load of the local network domain. In this context, admission control denotes subscriber admission control in 3G networks implemented by standardized policy management functionality. The admission control has two purposes in a 3G network:

to verify administrative rights of a user for the call or connection (CN [Core Node) EDGE); and

to control whether the required resources are available (MT [Mobile Terminal], UTRAN [IMTS Terrestial Radion Access Network], CN EDGE and Gateway).

The relationship between admission control and QoS is based on different network load factor Key Performance Indicators (KPIs), which can be measured within the network. These factors can include, for example, edge-to-edge delay, network load in the local network domain, available bandwidth in the domain, available radio channels and channel types, and Bit Error Rate (BER) . All of these values can be used to tune up the multidimensional admission control (MDAC) model. However, since all admission control decisions have to be decided per subscriber, the execution load in the admission control unit can be relatively high.

It is an aim of embodiments of the present invention to provide an improved method and apparatus for implementing policy based decisions in a communications network. In a particularly preferred form, the aim of embodiments of the invention is to reduce the execution load associated with implementing admission control procedures in a 3G network.

According to a first aspect of the present invention there is provided an admission control unit for users in a wireless communication system, said unit being arranged to control the admission of calls arriving from the users depending on a parameter which is representative of the load in said system, wherein the load parameter is derived from a fuzzy logic composition of at least two indicators, each defining different performance characteristics of the load in said system.

According to another aspect of the present invention there is provided a method for controlling the admission of calls in a wireless communication network having a load, the method comprising the step of: receiving at least two indicators each defining a different performance characteristic of the load in the network; combining said indicators using fuzzy logic to determine a parameter representative of the load of the network; and deciding based on said load parameter whether to admit calls arriving from the users.

According to a further aspect of the present invention there is provided a wireless communication system having a load formed by calls transferred between users of the system, the system comprising means for controlling the admission of calls arriving from the users depending on a parameter which is representative of the system load, wherein the value of the load parameter is a fuzzy logic combination of at least two indicators each defining different performance characteristics of load in the system.

### BRIEF DESCRIPTION OF INVENTION

Preferred embodiments of the invention will now be described, by way of example only, with reference to the accompanying drawings, in which:

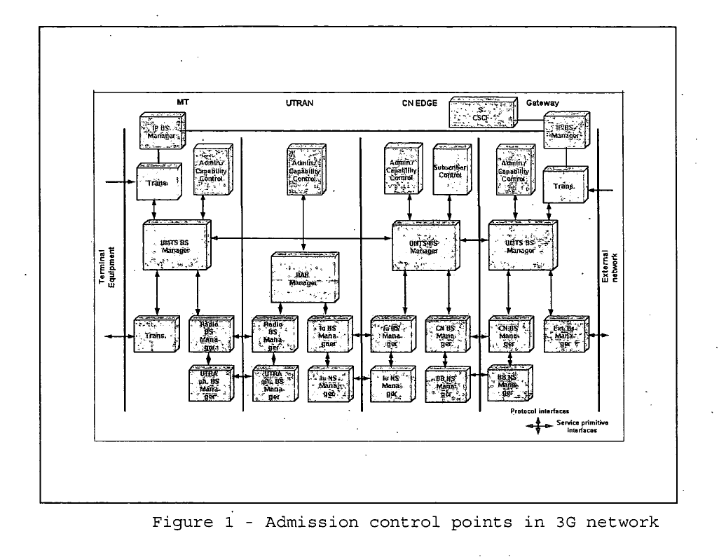

FIG. 1 shows admission control points in a 3G network, in which the invention is implemented;

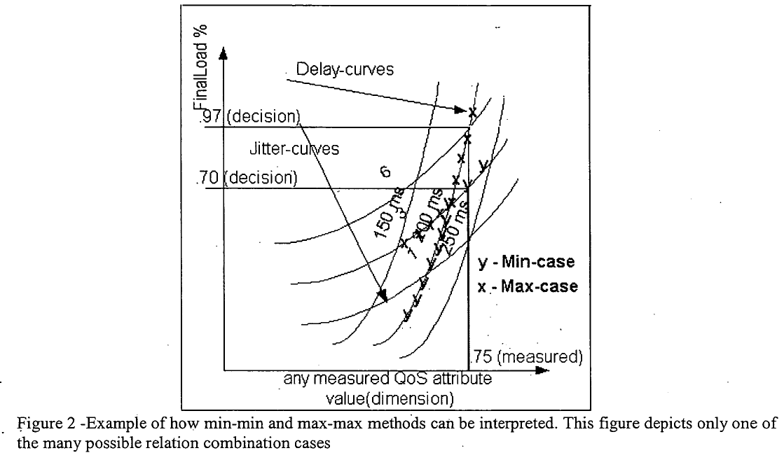

FIG. 2 shows an example of min-min and max-max interpretation of data, in accordance with the invention;

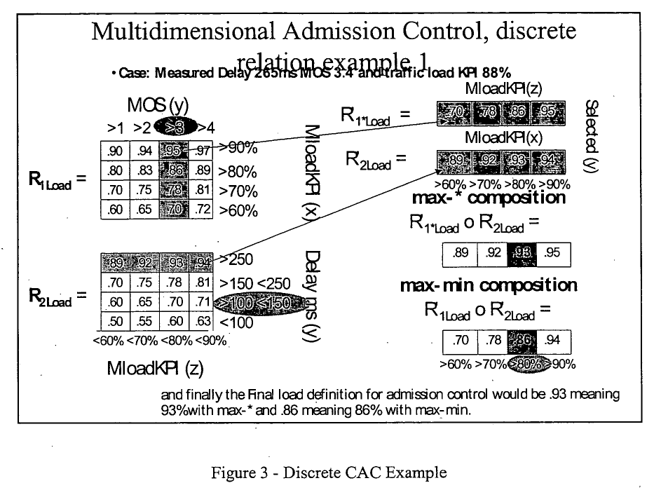

FIG. 3 shows a discrete Call Admission Control (CAC) embodiment of the invention;

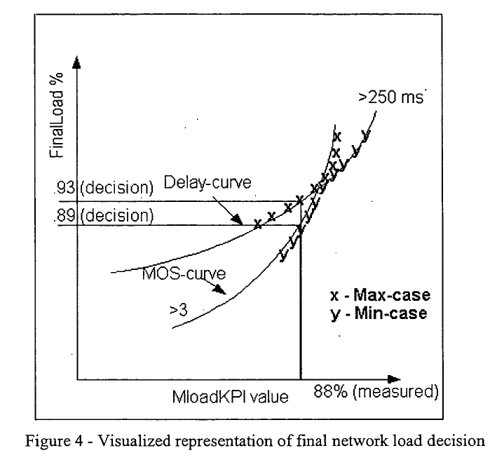

FIG. 4 is a visual representation of a network load decision made in accordance with an embodiment of the invention;

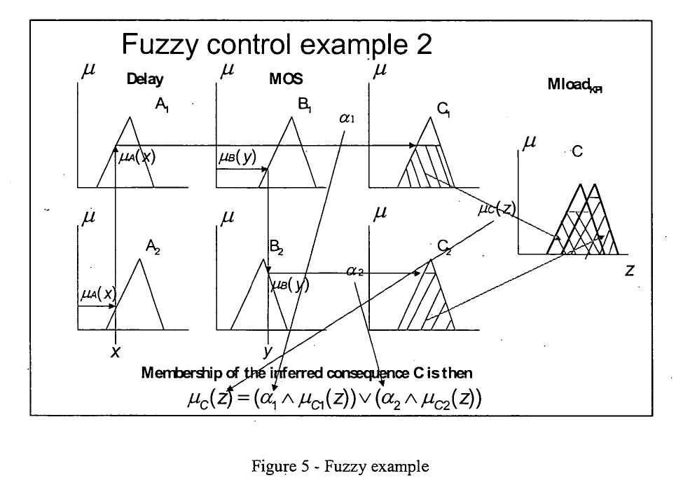

FIG. 5 shows an implementation of an embodiment of the invention; and

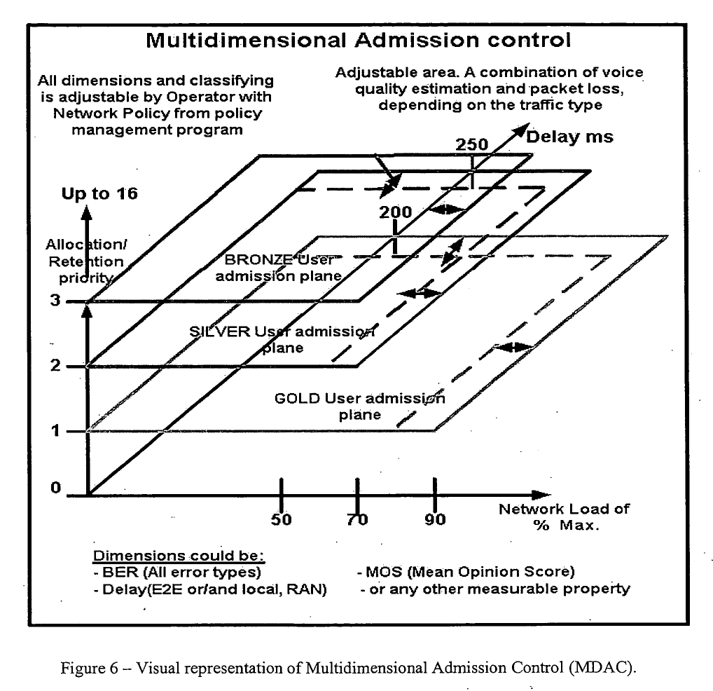

FIG. 6 is a visual representation of a Multidimensional Admission Control (MDAC) structure, in accordance with an embodiment of the invention.

### DETAILED DESCRIPTION OF PREFERRED EMBODIMENTS

QoS control is based on correctly operating admission control (i.e. controlling user access) to offer adequate network resources for 3G QoS on IP and UMTS layers. The relationship between admission control and QoS is based on different network load factors (KPIs) which can be obtained from the network.

FIG. 6 depicts the basic idea of the multidimensionality of the QoS attributes (or KPIs). All of the QoS attributes mentioned in the 3GPP [TS23.107] standard can be used as part of the dynamically tuned delay or load part or they can be split into separate dimensions in the admission control plane. TS23.107 is hereby incorporated by reference.

Each of the KPIs are to some extent related to each other and they are not fully independent and orthogonal. Also, the correlation between KPIs varies in every environment, for example as a result of different configurations (or combination of devices), traffic mixes or network loads.

Therefore, a technique is needed that can take into account the various KPIs and varying environmental conditions so as to dynamically and flexibly tune to the network conditions.

Although it is expected that fuzzy logic theory is well known to those skilled in the art and beyond the scope of the present invention, it is useful to provide a brief summary of the important characteristics of fuzzy logic used by embodiments of the present invention.

Broadly speaking, fuzzy logic provides a more general definition than conventional Boolean logic. Specific systems have parameters that are defined as either being false “0” or true “1” which are often referred to as “crisp” numbers, however by using a range of continuous values between “0” and “1” fuzzy logic is extended so as to incorporate the idea of partial truth. So-called “fuzzy subsets” (also known as “membership functions” which will be referred to hereinafter) are another important characteristic of fuzzy logic, and allow values of a system to be better defined in terms of their partial truth.

This is best illustrated by a simple physical example which is often used. Consider the set S as being the set of “people” and a fuzzy subset TALL is defined which will answer the question “to what degree is a person x (in the set of people S) tall?”. In defining the system it is necessary to assign to each person a degree of membership in the subset TALL. The easiest way to do this is with a membership function based on the person's height. For example, each person's height could be represented as a degree of tallness based on the membership function. Membership functions are capable of taking many different forms and are often represented as triangles as shown in the waveforms of FIG. 5 (which will be discussed later), but can also be a simple straight line or more complex functions.

The real benefit of membership functions and fuzzy logic is that they can often be based on more than one characteristic (or subset). So, in the example, it is possible to re-define a membership function to take into account both height and age so that a person can be judged on being “tall for their age”. This is often referred to as a fuzzy relation (or two-dimensional membership function).

A fuzzy system is defined by a collection of membership functions and rules (i.e. rule base) to reason about data. The term “composition” refers to the process when all of the fuzzy subsets assigned to a variable (or set) are combined together to form a single fuzzy subset. Various compositions are possible and embodiments of the present invention describe using max-* and max-min compositions. Moreover, “defuzzification” is an optional process which can be used to convert from a fuzzy number to a crisp number.

Thus the use of fuzzy logic is ideal for modelling complex real world systems and is therefore perfectly suited for admission control of telecommunication network having a plurality of potentially correlated KPIs. That is, fuzzy logic is able to take into account the correlation between each KPI or at least can be expressed as a fuzzy relation with a membership function that describes the extent that the KPIs in question are related to each other.

The preferred embodiment is a method and corresponding apparatus for implementing a Multidimensional Admission Control (MDAC) in a 3G network. The embodiments make use of an Allocation/Retention Priority (ARP) value. In this description, the term multidimensionality refers to the incorporation of multiple measured network KPIs into one subscriber admission control load value, referred to herein as Mload_{KPI}. The value of the Mload_{KPI} can be any combination of available KPIs.

In the preferred embodiment, multidimensional admission control (MDAC) is implemented in fuzzy logic using max-min or max-* composition. The multidimensionality is based on, for example, the following factors: edge-to-edge delay, BER, price factor and Mload_{KPI} parameter. Each of these factors represents a measure of network quality at a particular time. The value of each factor represents a certain portion of resource load, e.g. network bandwidth, and overall delay budgeting and jitter. By defining how these factors correlate to the total or specific load (bandwidth, delay, etc.), there is generated a series of crossing curves where y presents Mload_{KPI} and each x presents one of the admission control dimensions. By using fuzzy logic max-min (or max-*) composition, it is possible to quickly define an admission load parameter Mload_{KPI}, which defines the curve to follow when defining an Mload_{KPI} admission decision value.

### Methematic Fuzzy Logic Deduction Model

Mathematically, the MDAC of the preferred embodiment is based on classical fuzzy logic max-* or max-min fuzzy relation, as shown in equations 1 and 2:

$$\begin{matrix}For max {-}^{*} : & \\ {\tilde{R}}_{{1}^{*}} ∘ {\tilde{R}}_{2} = \{ ( ( x , z ) , {max}_{y} ( {μ}_{{R}_{1}} ( x , y ) * {μ}_{{R}_{2}} ( y , z ) ) ) \vert x ∈ X , y ∈ Y , z ∈ Z \} & ( 1 ) \\ and for max \text{-} min : & \\ {\tilde{R}}_{1} ∘ {\tilde{R}}_{2} = \{ ( ( x , z ) , {max}_{y} ( min ( {μ}_{{R}_{1}} ( x , y ) * {μ}_{{R}_{2}} ( y , z ) ) ) ) \vert x ∈ X , y ∈ Y , z ∈ Z \} & ( 2 )\end{matrix}$$

in which x, y and z can represent any three dimension admission parameter combination. In this case the membership functions μ_{R1} and μ_{R2} are fuzzy values for the traffic load in the network domain.

Examples of the fuzzy logic model as applied are shown in Table 1 and Table 2. In those tables, it can be seen that the load function F(x)=y can be defined with only a few points calculated and inserted into a 2-dimensional table. These tables can then be combined with the max-min fuzzy logic model.

Once deduced in this manner, the Mload_{KPI} parameter is used for a connection admission control decision.

This relation deduction model can also be used in a non-fuzzy form. It can be done by removing membership functions μ_{R1} and μ_{R2} from formulas 1 and 2 and replacing them with discrete values obtained from the discrete functions F_{R1} and F_{R2} in equations 3 and 4.

$$\begin{matrix}For max {-}^{*} : & \\ {R}_{{1}^{*}} ∘ {R}_{2} = \{ ( ( x , z ) , {max}_{y} ( {F}_{{R}_{1}} ( x , y ) * {F}_{{R}_{2}} ( y , z ) ) ) \vert x ∈ X , y ∈ Y , z ∈ Z \} & ( 3 ) \\ and for max \text{-} min : & \\ {R}_{1} ∘ {R}_{2} = \{ ( ( x , z ) , {max}_{y} ( min ( {F}_{{R}_{1}} ( x , y ) * {F}_{{R}_{2}} ( y , z ) ) ) ) \vert x ∈ X , y ∈ Y , z ∈ Z \} & ( 4 )\end{matrix}$$

Variables in the formula are:

R₁ and R₂: Relation tables constructed from functions F_{R1} and F_{R2}; and

x, y and z and are the parameters for functions F_{R1} and F_{R2}.

If discrete functions F_{R1} and F_{R2} are used, the final value generated is a real measure (%) of the actual network load in the domain, which can be used in making an admission decision.

### Multidimensional Admission Control Discrete Logic Example 1

The next example depicts the functionality of the MDAC using two 2-D tables where the dimension y is the Mload_{KPI} value and each of the other parameters can be any desired traffic property such as delay, Mean Opinion Score (MOS), jitter etc. It will be appreciated that any suitable number of tables can be used.

Parameters such as delay can also be fuzzy, as in the example. The goal is to determine what is the FinalLoad value for the call admission control (CAC) decision.

A relation approximation table is provided for each of the dimensions of interest:

TABLE 1
Mload_{KPI}(z)/Measured Delay (y) Table
$\begin{matrix}{Mload}_{KPI} ( z ) \\ {\tilde{R}}_{1} = [ \begin{matrix}> 70 \% & > 80 \% & > 90 \% & > 95 \% & \\ .89 & .92 & .93 & .94 & > 250 ms \\ .70 & .75 & .78 & .81 & > 150 \leq 250 ms \\ .60 & .65 & .70 & .71 & > 100 \leq 150 ms \\ .50 & .55 & .60 & .63 & \leq 100 ms\end{matrix} ] Delay ( y )\end{matrix}$

For the relation, it is also necessary to obtain a measurement value from the network. The next table depicts the values and value ranges of the dimension, although only one value pair can be achieved from the network at a time in real life.

TABLE 2
Mload_{KPI}/Measured Jitter(y) Table
$\begin{matrix} Jitter ( y ) \\ {\tilde{R}}_{2} = [ \begin{matrix}< 1 ms & < 3 ms & < 6 ms & < 12 ms & \\ .90 & .94 & .95 & .97 & > 95 \% \\ .80 & .83 & .86 & .89 & > 90 \% \\ .70 & .75 & .78 & .81 & > 80 \% \\ .60 & .65 & .70 & .72 & > 70 \%\end{matrix} ] {Mload}_{KPI} ( y )\end{matrix}$

For a measured Delay of 120 ms and Jitter of 5 ms, then corresponding rows and columns from the tables 1 and 2 are determined, as shown in tables \tilde{R}′₁ and \tilde{R}′₂:

$$\begin{matrix}{Mload}_{KPI} ( z ) \\ {\tilde{R}}_{1}^{′} = [ \begin{matrix}> 70 \% & > 80 \% & > 90 & > 95 \% \\ .60 & .65 & .70 & .71\end{matrix} ] Selected ( y ) \\ {\tilde{R}}_{2}^{′} = [ \begin{matrix}> 70 \% & > 80 \% & > 90 \% & > 95 \% \\ .70 & .78 & .86 & .95\end{matrix} ] Selected ( y )\end{matrix}$$

The next step is to make the relation between \tilde{R}′₁ and \tilde{R}′₂ which is marked as \tilde{R}′₁∘\tilde{R}′₂=\tilde{R}₃. The max-max composition would then be:

$$\begin{matrix}{Mload}_{KPI} ( z ) \\ {\tilde{R}}_{{1}^{*}}^{′} ∘ {\tilde{R}}_{2}^{′} = [ \begin{matrix}> 70 \% & > 80 \% & > 90 \% & > 95 \% \\ .97 & .97 & .97 & .98\end{matrix} ] FinalLoad ( x ) \\ and max \text{-} min case : \\ {Mload}_{KPI} ( z ) \\ {\tilde{R}}_{1}^{′} ∘ {\tilde{R}}_{2}^{′} = [ \begin{matrix}> 70 \% & > 80 \% & > 90 \% & > 95 \% \\ .70 & .75 & .75 & .75\end{matrix} ] FinalLoad ( x )\end{matrix}$$

The next step is to get the value of Mload_{KPI} from the system and select the appropriate FinalLoad value from the max-* or max-min relation table. This means that if a measured Mload_{KPI} value is 75%, the FinalLoad would be 0.97 in max-* case and 0.70 in max-min case. In this case the fuzzy membership function value is a measure and value of association for the parameter to a measurement dimension. In this case the fuzzy function value has been directly translated into a network load value.

FIG. 2 depicts how the min and max methods should be interpreted. In the min -case the decision system always chooses the path that produces the lowest Mload_{KPI} value, whereas the max case is the opposite, in that the highest Mload_{KPI} value is used. All of the parameter values can be fuzzy or discrete.

### Multidimensional Admission Control Discrete Logic Example 2

FIG. 3 presents a simple practical example for determining a final load factor definition by discrete relation. Case parameters are: MOS 3.4 and Delay of 265 ms. In the example, predefined mapping tables R_{1Load} and R_{2Load} are used. These tables may be achieved by RT-measurements (real time) from the network or by theoretical simulations. The tables can be short-term or long-term controlled as required and they act as the main tuning and configuration point to the CAC.

The first phase is to measure or calculate domain MOS and Delay values for the first stage, R′_{1Load} and R′_{2Load} relation vector selections. All values can be fuzzy membership or discrete values.

In the second phase we make max-* or max-min relation operation between the determined 1-D vectors. The result is two vectors, which can be used as the FinalLoad descriptor for the domain. The final load selection is then executed by selecting the column that corresponds to the MloadKPI value achieved from the KPI calculation. The next figure visualizes the selection functionality and the way the decision is related to the “near” by MOS and delay values.

As can be seen from FIG. 4, the load selection changes from the delay curve to the MOS curve as the load value changes from 70% to 80% whilst moving upwards along the curves. The situation will be the same with any other crossing property mapping case.

Also FIG. 4 shows that the basic load value of 88% changes into z=89% in the min case and z=93% in the max case. This change means that the delay is the dominant KPI in the min case, whereas MOS is the dominant KPI in the max case.

### Multidimensional Admission Control Fuzzy Logic Example

In a Fuzzy logic case we use same kinds of mapping tables as presented in the previous discrete examples. The difference between the fuzzy and discrete cases is the interpretation of the values in the table and the way values are achieved from the real performance system of a 3G network.

In discrete case it is assumed that there is always a dominant QoS attribute, which defines the final Mload_{KPI} leading to FinalLoad values. In the fuzzy case, the values in the table are membership values, which have to be defuzzified in order to get the final decision value FinalLoad. FIG. 5 depicts the decision process in the fuzzy case.

In the fuzzy case, the same tables as shown in the discrete example are used, but the difference is the interpretation of the values in the tables and of course the way the values are calculated from the real performace of a 3G network. Therefore, in the fuzzy case, the values in the tables are membership values requiring more computation effort to calculate than the pre-defined discrete values. The membership values can be calculated using a variety of so-called “T-norms”, which are well known and are beyond the scope of the present invention. That is, in the fuzzy case the values also need to be defuzzified in order to get a final Mload_{KPI}.

In the fuzzy case, a fuzzification process needs to be undergone as shown in FIG. 5, in which the membership values of the KPIs, i.e. Delay and MOS, are fuzzified to form the fuzzified values α₁ and α₂ respectively. Also, Mload_{KPI} is represented as the μ_{c}(z) fuzzified value.

As can be seen in the example, the inferred consequence C can be calculated from equation 5.

μ_{c}(z)=(α₁ [symbol] μ_{c1}(z)) [symbol] μ_{c2}(z)) (5)

From this, we can conclude and make ruling and relation as equation 6:

\tilde{R}ₖ=Ãₖ→\tilde{B}ₖ (6)

Ruling can also be expressed for a common N rule case, equation 7:

\tilde{R}=Uₖ₌₁^{N}\tilde{R}ₖ (7)

This example case can also be put into another form: If the Delay x₁ is Ã₁ and x₂ is Ã₂ then \tilde{R}_{A}=Ã₁∘Ã₂ and MOS y₁ is B₁ and y₂ is B₂ then \tilde{R}_{B}=\tilde{B}₁∘\tilde{B}₂. Then we can say \tilde{R}_{C}=\tilde{R}_{A}∘\tilde{R}_{B}

The value for z (Mload_{KPI} in the example) can then be calculated from equation 8, which in this embodiment will provide the MOM (Mean of Max) in the result of FIG. 5:

$$z = \frac{{\sum }_{k = 1}^{N} {α}_{k} {H}_{k} {W}_{k}}{{\sum }_{k = 1}^{N} {α}_{k} {H}_{k}} \qquad ( 8 )$$

where Wk is the value where the membership function Hk reaches its maximum (i.e. “1” if normalized).

The final admission control decision can then be made according to the following decision rules:

Gold class example:

TABLE 3
Call admission decision example

| | Blocking threshold | Dropping threshold | |
|---|---|---|---|
| Final load value z | value | value | Admission decision |
| 73% load (0.73 form | 75% | 80% | Call admitted |
| Fuzzy system) | | | No call dropping |
| 83% load (0.83 form | 80% | 85% | Call not admitted |
| Fuzzy system) | | | No call dropping |
| 92% load (0.92 form | 85% | 90% | Call not admitted |
| Fuzzy system) | | | Gold class calls dropped |

All other subscriber classes will be handled in a similar way. Only the threshold values will be different, lower for lower class subscribers. There will also be a special class, which will bypass all the other classes. It uses an ARP value 0 and it is for government, official and emergency call priorities. In some cases the ARP value 0 can be used for both official and Gold subscriber classes. The rules used for the rule based admission control system can be in the following form.

For call Blocking:

If Mload_{KPI}=GoldBlockingThresholdValue then Block all GoldUserCallType and SilverUserCallType and BronzeUserCallType and EconomyUserCallType

If Mload_{KPI}=SilverBlockingThreshold Value then Block all SilverUserCallType and BronzeUserCallType and EconomyUserCallType

If Mload_{KPI}=EconomyBlockingThresholdValue then Block all EconomyUserCallType

And in general

If Mload_{KPI}=xxxBlockingThresholdValue then Block all xxxUserCallType and (all other lower priority user class calls)

For call Dropping:

If Mload_{KPI}=GoldDroppingThresholdValue then Drop all GoldUserCallType and SilverUserCallType and BronzeUserCallType and EconomyUserCallType

If Mload_{KPI}=EconomyBlockingThresholdValue then Drop all EconomyUserCallType

And in general

If Mload_{KPI}=xxxBlockingThresholdValue then Drop all xxxUserCallType and (all other lower priority user class calls)

This model is compatible with the Internet Engineering Task Force (IETF) standards and a policy based control model with extendedactions (here Blocking and Dropping) that are concern with other actions over and above the packet flow type actions defined within a PEP(Policy Enforcement Point). It is envisaged that a new extended definition for PEP functionality, for example defined as Extended PEP (EPEP) could be used in this context, wherein the extended actions here would also be call dropping and call blocking actions.

It should also be appreciated that elements such as LPDP (Local Policy Decision Point) and PEP (Policy Enforcement Point) are part of Policy Base management standard. The LPDP is the point where policy decisions are actually made whereas the PEP is the point where the policy descsions are actually enforced. Although policy based management is not mandatory with MDAC, it is envisaged in other embodiments that MDAC could supplement and cooperate nicely with policy based management standards. For example, in a policy based management system the functionality of the MDAC could be implemented within a PEP, or at least could cooperate closely with the PEP. MDAC provides the FinalLoad KPI value to policies (rules) applied in PEP on the arriving calls from the subscribers to the network.

All QoS attribute parameter values mentioned in 3GPP [TS23.107] can be used as a part of the dynamically tuned delay or load part or they can be separate dimensions in the admission control plane.

The embodiments of the present invention have described max-min and max-* composition techniques, however it should be appreciated that other fuzzy logic composition techniques such as min-min and min-max can also be used.

It should be appreciated that the values used in the tables of the described embodiments are fictional and should be set for each real network environment individually by a process of preliminary network design. In this way values can be tuned to suit the exact network characteristics by using normal network design/redesign autotuning mechanisms.

The present embodiments can be used for 3G network admission control development work, tuning of an existing 3G admission control system and finding optimal operating parameters for the operating admission control product. As mentioned, the present invention in other embodiments can implement policy-based decision-making in any suitable element in a telecommunications network.

Although the invention has been described with reference to a number of specific embodiments, it will be appreciated by those skilled in the art that the invention can be embodied in many other forms.

1. An admission control unit for users in a wireless communication system, said unit being arranged to control the admission of a call arriving from a user depending on a parameter which is representative of load in said system, wherein the parameter is derived from a fuzzy logic composition of at least two indicators, each defining different performance characteristics of the load in said system.

2. The unit according to claim 1, wherein the load parameter and indicators are membership functions having fuzzy values.

3. The unit according to claim 1, wherein the load parameter and indicators are discrete functions having discrete values.

4. The unit according to claim 2, wherein the membership function is a triangle.

5. The unit according to claim 2, wherein the membership function is a straight line having a slope with either increasing or decreasing gradient.

6. The unit according to claim 1, wherein the admission control unit is implemented in at least one policy-based element of the wireless communication system that uses rule-based logic for configuration and dynamic tuning.

7. The unit according to claim 1, wherein the fuzzy logic composition is max-* composition.

8. The unit according to claim 1, wherein the fuzzy logic composition is max-min composition.

9. The unit according to claim 1, wherein at least one of two indicators is a quality of supply attribute of the load.

10. The unit according to claim 9, wherein said indicators comprise one or more of the following: jitter, delay, BER, MOS or bandwidth capacity.

11. The unit according to claim 10, wherein the indicators are at least to some extent orthogonal to each other.

12. A method for controlling the admission of calls in a wireless communication network having a load, the method comprising the step of:
receiving at least two indicators each defining a different performance characteristic of the load in the network;
combining said indicators using fuzzy logic to determine a parameter representative of the load of the network; and
deciding based on said load parameter whether to admit a call arriving from a user.

13. The method according to claim 12, wherein the step of receiving at least two indicators comprises forming a table for each indicator having values corresponding to the load parameter.

14. The method of claim 13, wherein the table values are discrete values.

15. The method of claim 13, wherein the table values are membership function values.

16. The method of claim 13, wherein a first and second set of values is selected from each table corresponding to the respective indicators depending on values of said indicators in the system.

17. The method according to claim 16, wherein in said combining step the first and second set of values are combined to form a third set using said fuzzy logic composition.

18. The method according to claim 17, wherein the load parameter is determined by selecting one of the values of the third set which corresponds to the indicator assumed to be most dominant of the at least two indicators.

19. A wireless communication system having a load formed by calls transferred between users of the system, the system comprising means for controlling the admission of calls arriving from the users depending on a parameter which is representative of the system load, wherein the value of the load parameter is a fuzzy logic combination of at least two indicators each defining different performance characteristics of load in the system.

20. The wireless communication system according to claim 19, comprising a plurality of cells at a cell level and at least one serving node of a general packet radio service (GPRS) type at a subscription level.

21. The wireless communication system according to claim 20, wherein the decision to admit a call is taken at the cell level.

22. The wireless communication system according to claim 20, wherein the decision to admit a call is taken at the subscription level.
